(19) United States
(12) Patent Application Publication
(10) Pub. No.: US 2017/0018189 A1
(43) Pub. Date: Jan. 19, 2017

(54) AUTOMATIC DRIVE ASSIST DEVICE, METHOD, AND PROGRAM FOR A VEHICLE

(71) Applicant: AISIN AW CO., LTD., Anjo-shi (JP)

(72) Inventor: Ken ISHIKAWA, Nagoya (JP)

(73) Assignee: AISIN AW CO., LTD., Anjo-shi (JP)

(21) Appl. No.: 15/124,517

(22) PCT Filed: Feb. 6, 2015
(86) PCT No.: PCT/JP2015/053374

§ 371 Date: Sep. 8, 2016

(30) Foreign Application Priority Data
Mar. 20, 2014 (JP) 2014-057943

(51) Int. Cl. G08G 1/16; G05D 1/00

(52) U.S. Cl. CPC G08G 1/167; G05D 1/0088; G05D 1/0061

(57) ABSTRACT

Automated drive assisting devices, methods, and programs for a vehicle acquire road information including information on a lane change prohibited section of a road on which the vehicle travels, and determine whether a lane change is to be made at a branch point for guidance positioned ahead of the vehicle during automated drive. The devices, methods, and programs determine, based on the road information, whether the vehicle is traveling on a road with the lane change prohibited section. When it is determined that a lane change is to be made at the branch point for guidance and the vehicle is traveling on the road on with the lane change prohibited section, the devices, methods, and programs cause the vehicle to make a lane change in a section other than the lane change prohibited section before the branch point for guidance.

### TECHNICAL FIELD

Related technical fields include automated drive assisting devices, methods, and programs that assist a vehicle during automated drive.

### BACKGROUND ART

A variety of technologies for assisting drive by a driver have been proposed in recent years.

For example, Japanese Patent Application Publication No. 2013-19803 (JP 2013-19803 A) discloses a drive assisting device that reports information on the start point or the end point of a lane change prohibited section in the case where it is determined that such a start point or an end point is present within a predetermined distance ahead of the travel location of a vehicle. This allows a driver who drives the vehicle to recognize the presence of the start point or the end point of the lane change prohibited section in advance. Thus, the driver can recognize in advance the timing when it becomes impossible to make a lane change or the timing when it becomes possible to make a lane change, which allows appropriate travel in consideration of a lane change.

### SUMMARY

In the drive assisting device described in JP 2013-19803 A, however, the driver is only informed of the presence of the lane change prohibited section (a section in which a lane change or overtaking is prohibited and which is provided before a branch point such as an intersection). Therefore, in the case where an automated drive system that makes a lane change is assumed, the document does not disclose making a lane change during automated drive in a section other than the lane change prohibited section on a road on which the lane change prohibited section is present.

Exemplary embodiments of the bread inventive principles described herein address the foregoing issue, and therefore have an object to provide an automated drive assisting device, an automated drive assisting method, and a program that enable a lane change during automated drive in a section other than a lane change prohibited section.

Exemplary embodiments provide automated drive assisting devices, methods, and programs for a vehicle that acquire road information including information on a lane change prohibited section of a road on which the vehicle travels, and determine whether a lane change is to be made at a branch point for guidance positioned ahead of the vehicle during automated drive. The devices, methods, and programs determine, based on the road information, whether the vehicle is traveling on a road with the lane change prohibited section. When it is determined that a lane change is to be made at the branch point for guidance and the vehicle is traveling on the road on with the lane change prohibited section, the devices, methods, and programs cause the vehicle to make a lane change in a section other than the lane change prohibited section before the branch point for guidance.

With the automated drive assisting device, the automated drive assisting method, and the program having the configuration described above, the vehicle is prohibited from making a lane change in the lane change prohibited section and controlled so as to make a lane change in a section other than the lane change prohibited section before the branch point for guidance in the case where it is determined during automated drive that a lane change is to be made at the branch point for guidance and it is determined that the vehicle is traveling on a road on which the lane change prohibited section is present. Consequently, a lane change can be made through automated drive outside the lane change prohibited section before the branch point for guidance.

### BRIEF DESCRIPTION OF THE DRAWINGS

FIG. 1 is a block diagram illustrating an example of the configuration of a vehicle.

FIG. 2 is a main flowchart illustrating “lane change assisting processing” executed in a navigation apparatus.

FIG. 3 is a sub flowchart illustrating sub processing “space securing deceleration processing” of FIG. 2.

FIG. 4 is a sub flowchart illustrating the sub processing “space securing deceleration processing” of FIG. 2.

FIG. 5 is a diagram illustrating an example of the along-the-way distance from the vehicle to a branch point for guidance.

FIG. 6 is an explanatory diagram illustrating an example of a lane change to be made in the case where there is a lateral space.

FIG. 7 is an explanatory diagram illustrating an example of a lane change to be made in the case where there is a lateral space but a lane change prohibition line is present.

FIG. 8 is an explanatory diagram illustrating an example of a lane change to be made in the case where there is no lateral space.

FIG. 9 is an explanatory diagram illustrating an example of a lane change to be made in the case where there is no lateral space and a lane change prohibition line is present.

FIG. 10 is an explanatory diagram illustrating an example of a lane change to be made in the case where the start point of a lane change prohibition line is present before a lane change completion location.

### DETAILED DESCRIPTION OF EXEMPLARY EMBODIMENTS

An automated drive assisting device, an automated drive assisting method, and a program, embodied as a navigation apparatus, according to an embodiment will be described in detail below with reference to the drawings.

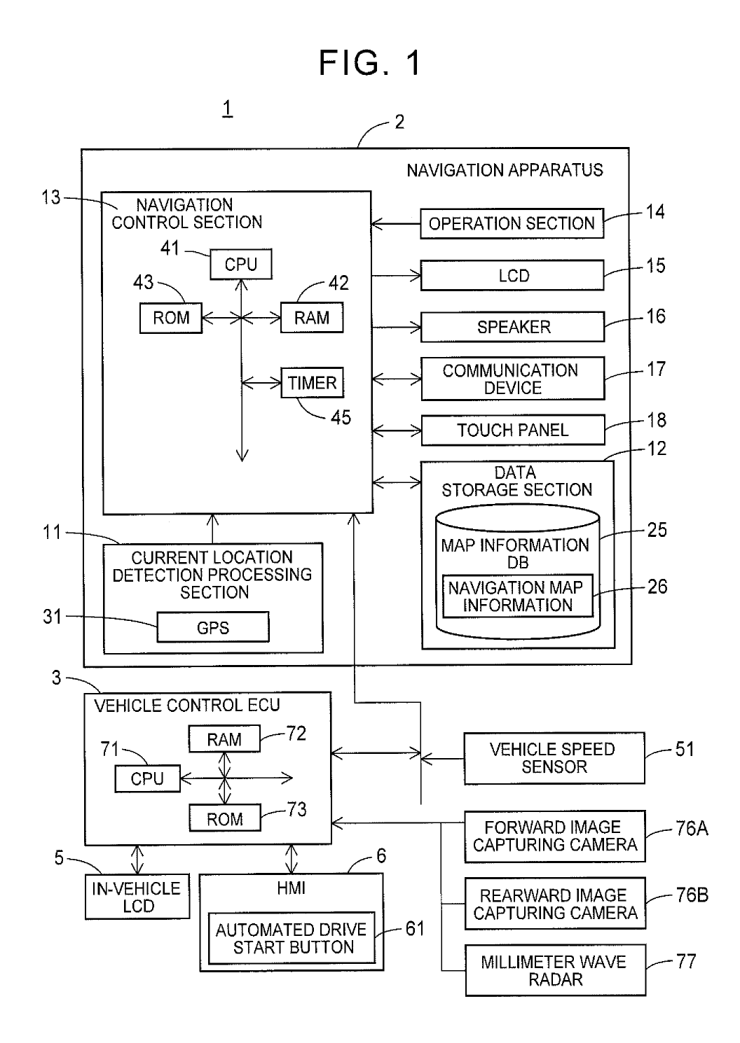

A schematic configuration of a vehicle 1 according to the embodiment will be described with reference to FIG. 1. As illustrated in FIG. 1, the vehicle 1 according to the embodiment is basically composed of a navigation apparatus 2 installed in the vehicle 1 and a vehicle control electronic control unit (ECU) 3,

The navigation apparatus 2 is provided in the center console or a panel surface in the cabin of the vehicle 1, and includes a liquid crystal display (LCD) 15 that displays a map of an area around the vehicle and a search route to a destination location, a speaker 16 that outputs audio route guidance, and so forth. The navigation apparatus 2 specifies the current position of the vehicle 1 through a GPS 31 etc., and in the case where a destination location is set, explores for a plurality of routes to the destination location and provides guidance on the set route for guidance using the liquid crystal display 15 and the speaker 16. The configuration of the navigation apparatus 2 will be discussed in detail later.

The vehicle control ECU 3 is an electronic control unit that controls the entire vehicle 1. In addition, a navigation control section 13 of the navigation apparatus 2 to be discussed later is connected to the vehicle control ECU 3. In addition, an in-vehicle display (in-vehicle LCD) 5 that displays a speedometer etc., a human interface (HMI) 6, a forward image capturing camera 76A, a rearward image capturing camera 76B, a millimeter wave radar 77, a vehicle speed sensor 51 that detects the vehicle speed, and so forth are connected to the vehicle control ECU 3.

The vehicle control ECU 3 includes a CPU 71 that serves as a computation device and a control device, and internal storage media such as a RAM 72 for use as a working memory when the CPU 71 performs various types of computation processing and a ROM 73 that stores a control program etc. (As used herein the terms “storage medium” and “storage media” are not intended to encompass transitory signals.) The CPU 71 prepares a drive plan on the basis of route data on a route for guidance received from the navigation control section 13 of the navigation apparatus 2, gradient information on each link on the route, link length, and so forth.

The human interface 6 is provided with an automated drive start button 61 for instructing start of automated drive etc. A driver can instruct the vehicle control ECU 3 to start automated drive by depressing the automated drive start button 61 to turn on the automated drive start button 61 on a toll road such as a national express highway, an urban expressway, and an ordinary toll road. The automated drive start button 61 is switched on and off each time a user depresses the automated drive start button 61. When the automated drive start button 61 is turned on, automated drive control is started. When the automated drive start button 61 is turned off, on the other hand, automated drive control is ended, and switching is made to manual drive performed by operations of the driver.

In the case where an instruction to start automated drive is input, the CPU 71 sets an interruption timing, at which switching is made from automated drive to manual drive by the driver, at an access road (ramp way) at the exit of the toll road, a toll gate (interchange), or the like on the route for guidance on the basis of the drive plan. For example, the CPU 71 sets an interruption timing at a position 300 m before the exit of the toll road. The CPU 71 controls drive of an engine device, a brake device, an electric power steering system, and so forth (not illustrated) to perform automated drive until the interruption timing on the route for guidance is reached.

The forward image capturing camera 76A is attached near the rearview mirror of the vehicle 1, constituted of a CCD camera or the like, and captures an image of a scene ahead of the vehicle and outputs an image signal to the vehicle control ECU 3. The rearward image capturing camera 76B is attached at the rear end portion of the vehicle 1, constituted of a CCD camera or the like, and captures an image of a scene behind the vehicle and outputs an image signal to the vehicle control ECU 3. The CPU 71 performs image processing on the image signals input from the forward image capturing camera 76A and the rearward image capturing camera 76B to detect the relative positions of other vehicles that are present around the vehicle 1 with respect to the vehicle 1, and outputs the detected relative positions to the navigation apparatus 2. In addition, the CPU 71 performs image processing on the image signals input from the forward image capturing camera 76A and the rearward image capturing camera 76B to detect a space around the vehicle 1, and outputs the detected space to the navigation apparatus 2.

The millimeter wave radar 77 is attached at the center position of the distal end portion and the center position of the rear end portion of the vehicle 1. The millimeter wave radar 77 detects the distances to other vehicles that are present around the vehicle 1 ahead of and in rear of the vehicle 1 and the relative speeds of the other vehicles which are present around the vehicle 1 with respect to the vehicle 1, and outputs data on the detected distances to the other vehicles which are present around the vehicle 1 and the detected relative speeds of the other vehicles which are present around the vehicle 1 with respect to the vehicle 1 to the vehicle control ECU 3. The CPU 71 detects the relative positions and the relative speeds of the other vehicles which are present around the vehicle 1 with respect to the vehicle 1 on the basis of the data on the distances to the other vehicles which are present around the vehicle 1 and the relative speeds of the other vehicles which are present around the vehicle 1 with respect to the vehicle 1 input from the millimeter wave radar 77, and outputs the detected relative positions and relative speeds to the navigation apparatus 2.

Subsequently, a schematic configuration of the navigation apparatus 2 will be described. As illustrated in FIG. 1, the navigation apparatus 2 according to the embodiment is composed of: a current location detection processing section 11 that detects the current position of the vehicle etc.; a data storage section 12 that stores various data; the navigation control section 13 which performs various types of computation processing on the basis of input information; an operation section 14 that receives an operation from an operator; the liquid crystal display (LCD) 15 which displays information such as a map for the operator; the speaker 16 which outputs audio route guidance etc.; a communication device 17 that communicates with a road traffic information center (not illustrated), a map information distribution center (not illustrated), and so forth via a cellular phone network or the like; and a touch panel 18 mounted to the surface of the liquid crystal display 15.

A remote controller, a joystick, a mouse, a touch pad, or the like may be provided in place of the touch panel 18.

The vehicle speed sensor 51 is connected to the navigation control section 13. In addition, the vehicle control ECU 3 is electrically connected to the navigation control section 13 so as to be able to acquire the relative positional relationship, the relative speeds, etc. of the other vehicles which are present around the vehicle 1 with respect to the vehicle 1.

The constituent elements which compose the navigation apparatus 2 will be described below. The current location detection processing section 11 is composed of the GPS 31 etc., and can detect the current position of the vehicle 1 (hereinafter referred to as “vehicle position”), the vehicle orientation, the travel distance, the elevation angle, and so forth. For example, the current location detection processing section 11 can detect the turning speeds for three axes using a gyro sensor, and can detect the travel direction for each of the orientation (horizontal direction) and the elevation angle.

The communication device 17 is configured to be able to receive the latest traffic information and weather information distributed from a probe center, a road traffic information center, or the like (not illustrated) at predetermined time intervals (e.g. at intervals of five minutes). The “traffic information” includes detailed information on traffic information such as travel time for each link, road congestion information on road congestions etc., and traffic restriction information on traffic restrictions due to a road work, a construction work, or the like, for example. For the road congestion information, the detailed information includes the actual length of the congestion, the time when the congestion is expected to be resolved, and so forth. For the traffic restriction information, the detailed information includes the period of duration of the road work, the construction work, or the like, the type of the traffic restriction such as a road closure, one-side alternating traffic, and a lane restriction, the time band of the traffic restriction, and so forth. The communication device 17 is configured to be able to bidirectionally communicate with communication devices mounted on vehicles around the vehicle 1.

The data storage section 12 includes: a hard disk (not illustrated) that serves as a storage medium; a map information database (map information DB) 25 stored in the hard disk; and a driver (not illustrated) configured to read a predetermined program etc. and write predetermined data into the hard disk. The map information DB 25 stores navigation map information 26 for use for the navigation apparatus 2 to provide travel guidance and search for a route.

The navigation map information 26 is composed of various kinds of information that are necessary for route guidance and map display, and composed of: newly built road information for specifying newly built roads; map display data for displaying a map; intersection data on intersections; node data on node points; link data on roads (links); search data for searching for a route; facility data on points of interest (POIs) such as shops which are a type of facilities; search data for searching for a location; and so forth, for example.

The stored node data include data on the coordinate (position) of a node set at a branch point (including an intersection, a T junction, etc.) of actual roads and set every predetermined distance in accordance with the radius of curvature etc. on the roads, the altitude of the node, the node attribute which represents whether the node corresponds to an intersection or the like, a connected link number list which is a list of link IDs which are the identification numbers of links connected to the node, an adjacent node number list which is a list of the node numbers of nodes that are adjacent to the node via a link, and so forth,

The stored link data include: for links that compose a road, data representing the link ID for specifying the link, the link length which indicates the length of the link, the coordinate position (e.g. the latitude and the longitude) of the start point and the end point of the link, the presence or absence of a median strip, the gradient of the link, the width of the road to which the link belongs, the number of lanes, the legal speed, the presence or absence of a lane change prohibition line, the coordinate position (e.g. the latitude and the longitude) of both end points of the lane change prohibition line, a railroad crossing, and so forth; for corners, data representing the radius of curvature, an intersection, a T junction, the entrance to and the exit from the corner, and so forth; and for road types, data representing general roads such as national roads, prefectural roads, and narrow streets, and toll roads such as national express highways, urban expressways, ordinary toll roads, and toll bridges.

For toll roads, further, data on access roads (ramp ways) for entry to and exit from the toll road, toll gates (interchanges), a toll for each travel section, and so forth are stored. National express highways, urban expressways, roads exclusive for automobiles, and ordinary toll roads that require a toll are called “toll roads”. Meanwhile, one- or two-digit-numbered national roads, three- or more-digit-numbered national roads, principal regional roads, prefectural roads, municipal roads, and so forth other than the toll roads are called “general roads”.

The stored search data include data for use to search for and display a route to a set destination location, and are composed of cost data for use to calculate an search cost composed of a cost for passage of a node (hereinafter referred to as “node cost”) and a cost for a link that composes a road (hereinafter referred to as “link cost”), route display data for displaying a route for guidance selected through route search on the map on the liquid crystal display 15, and so forth. The link cost is data that indicate the average travel time required to pass through the link, and may be “3 (min)”, for example,

The stored facility data include data such as the name, the address, the telephone number, the coordinate position (e.g. the longitude and the latitude of the center position, the entrance, the exit, etc.) on the map, and the facility icon or the landmark, which displays the position of the facility on the map, of POIs such as hotels, amusement parks, palaces, hospitals, gas stations, parking lots, stations, airports, ferry terminals, interchanges (ICs), junctions (JCTs), service areas, and parking areas (PAs) in each area, stored together with facility IDs that specify the POIs. In addition, registered facility IDs that specify registered facilities such as convenience stores and gas stations registered by a user are also stored.

The content of the map information DB 25 is updated by downloading update information distributed from the map information distribution center (not illustrated) via the communication device 17.

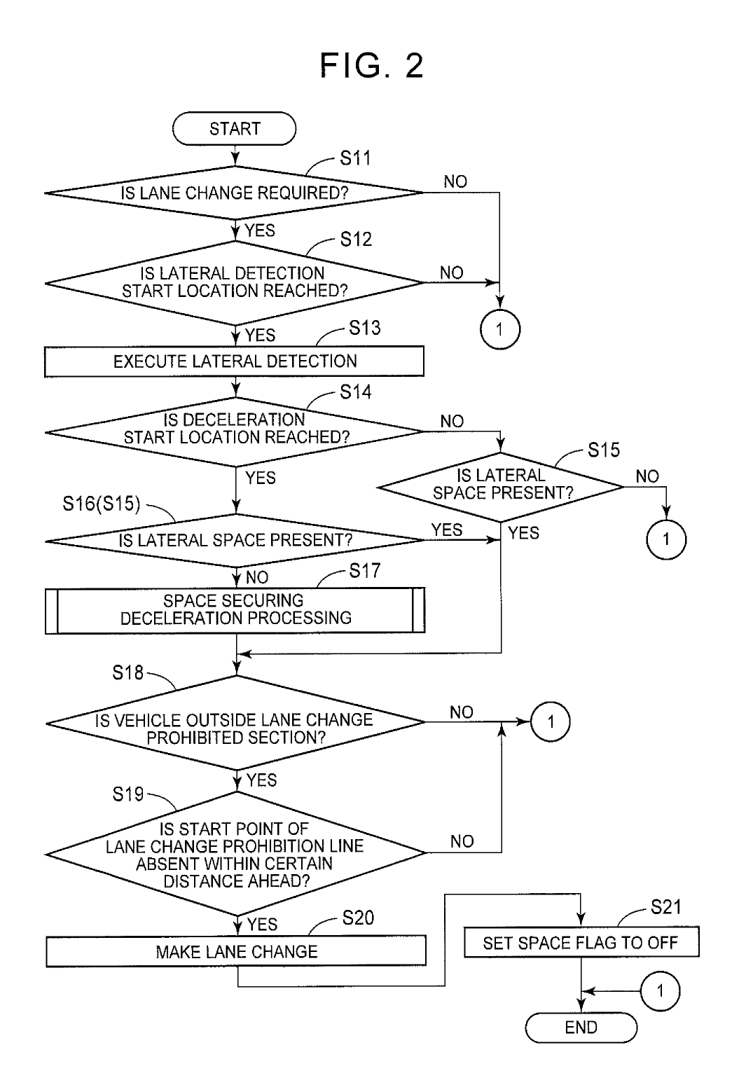

As illustrated in FIG. 1, the navigation control section 13 which constitutes the navigation apparatus 2 includes a CPU 41 that serves as a computation device and a control device that control the entire navigation apparatus 2, internal storage devices such as a RAM 42 for use as a working memory when the CPU 41 performs various types of computation processing and that stores route data when a route is found etc. and a ROM 43 that stores a control program, a timer 45 that measures a time, and so forth. The ROM 43 also stores a program for “lane change assisting processing” (see FIG. 2) for performing lane change instruction control on the vehicle control ECU 3 by setting a lateral space detection start location, a deceleration start location, a lane change start location, a lane change completion location, and so forth to be discussed later.

The operation section 14 is operated to correct the current position at the time of start of travel, input a departure location at which guidance is started and a destination location at which guidance is ended, make a search for information on a facility, and so forth, and composed of various types of keys and a plurality of operation switches. The navigation control section 13 performs control to execute various types of corresponding operation on the basis of a switch signal output by depressing each switch, for example.

The liquid crystal display 15 displays map information on an area in which the vehicle is currently traveling, map information on an area around the destination location, operational guidance, an operation menu, key guidance, a route for guidance from the current location to the destination location, guidance information on a travel along the route for guidance, traffic information, news, weather forecasts, the time, mails, television programs, and so forth.

The speaker 16 outputs audio guidance on a travel along the route for guidance on the basis of an instruction from the navigation control section 13. Examples of the audio guidance include “Turn right at ∘∘ intersection 200 m ahead”.

The touch panel 18 is a touch switch in the form of a transparent panel mounted on the display screen of the liquid crystal display 15, and is configured such that various instruction commands can be input by depressing a button or a map displayed on the screen of the liquid crystal display 15, for example. The touch panel 18 may be constituted of a liquid crystal with an optical sensor that is operable by directly depressing the screen of the liquid crystal display 15 or the like.

Next, the “lane change assisting processing”, which is processing executed by the CPU 41 of the navigation apparatus 2 in the vehicle 1 configured as described above to perform lane change instruction control on the vehicle control ECU 3 by setting a lateral space detection start location, a deceleration start location, a lane change start location, a lane change completion location, and so forth, will be described with reference to FIGS. 2 to 10. A program illustrated in the flowchart of FIG. 2 is processing executed at intervals of a predetermined time, e.g. at intervals of 0.1 seconds, while automated drive is continued in the case where a signal indicating that automated drive has been started is input from the vehicle control ECU 3. In the case where the automated drive start button 61 is depressed to be turned on on a toll road, the vehicle control ECU 3 starts automated drive, and thereafter outputs an automated drive start signal indicating that automated drive has been started to the navigation apparatus 2.

As illustrated in FIG. 2, first, in step (hereinafter abbreviated as “S”) 11, the CPU 41 of the navigation apparatus 2 acquires the vehicle position on the basis of the result of the detection performed by the current location detection processing section 11. Then, the CPU 41 acquires information on the path ahead in the travel direction of the vehicle 1. For example, the CPU 41 acquires information on the path within 10 km along the route for guidance (planned travel path) from the vehicle position. Subsequently, the CPU 41 executes determination processing in which it is determined whether or not a branch point for guidance that requires a lane change is present ahead of the vehicle, that is, whether or not a lane change is required. Then, in the case where it is determined that a branch point for guidance that requires a lane change is not present ahead of the vehicle (S11: NO), the CPU 41 ends the processing.

In the case where it is determined that a branch point for guidance that requires a lane change is present ahead of the vehicle (S11: YES), on the other hand, the CPU 41 proceeds to the processing in S12. In S12, the CPU 41 acquires the along-the-way distance from the vehicle position to the branch point for guidance which requires a lane change ahead of the vehicle, which excludes a lane change prohibited section defined by a lane change prohibition line along the route for guidance (planned travel path) from the vehicle position, and stores the acquired along-the-way distance in the RAM 42 as the distance from the vehicle position to the branch point for guidance.

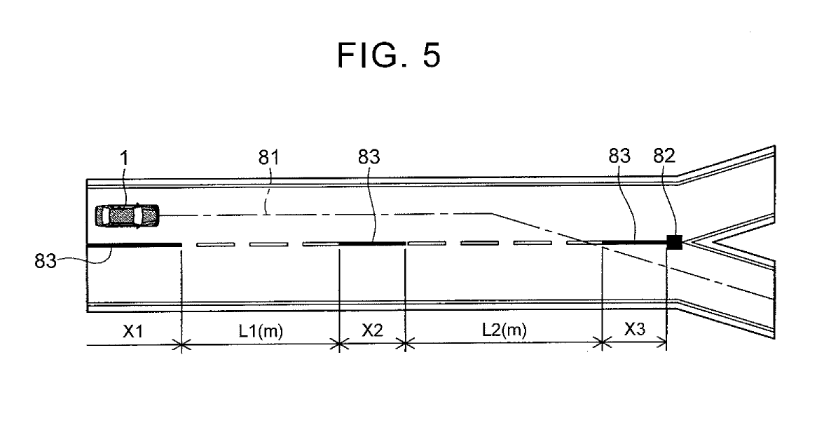

For example, as illustrated in FIG. 5, the CPU 41 calculates, on the basis of the navigation map information 26, the along-the-way distance (L1+L2) (m) from the vehicle position to a branch point for guidance 82 that requires a lane change ahead of the vehicle, which excludes lane change prohibited sections X1, X2, and X3 defined by lane change prohibition lines 83 along a route for guidance 81 from the vehicle position at which the vehicle 1 is positioned, and stores the acquired along-the-way distance as the distance from the vehicle position to the branch point for guidance 82.

Subsequently, the CPU 41 executes determination processing in which it is determined whether or not the distance from the vehicle position to the branch point for guidance has reached a distance at which detection of a space that allows a lane change is started, that is, whether or not the vehicle position has reached a lateral detection start location at which detection of a space that allows a lane change is started, i.e. whether or not the vehicle has passed the lateral detection start location. The CPU 41 determines that the vehicle position has reached the lateral detection start location, i.e. the vehicle has passed the lateral detection start location, when the distance from the vehicle position to the branch point for guidance which requires a lane change ahead of the vehicle has become equal to or less than 3 km, for example.

Then, in the case where it is determined that the distance from the vehicle position to the branch point for guidance has not reached the distance at which detection of a space that allows a lane change is started, that is, that the vehicle position has not reached the lateral detection start location (S12: NO), the CPU 41 ends the processing.

In the case where it is determined that the distance from the vehicle position to the branch point for guidance has reached the distance at which detection of a space that allows a lane change is started, that is, that the vehicle position has reached the lateral detection start location, i.e. that the vehicle has passed the lateral detection start location (S12: YES), the CPU 41 proceeds to the processing in S13.

In S13, the CPU 41 requests the vehicle control ECU 3 to measure a lateral space around the vehicle 1 in a lane to which a lane change is to be made. Consequently, the CPU 71 of the vehicle control ECU 3 measures the lateral space of the vehicle 1 in the lane to which a lane change is to be made by performing image processing on image data captured by the forward image capturing camera 76A and image data captured by the rearward image capturing camera 76B, or using the millimeter wave radar 77, and outputs the measured lateral space to the navigation apparatus 2.

Then, when data such as the distance of the lateral space of the vehicle 1 in the lane to which a lane change is to be made, e.g. data on the relative positional relationship and the relative speeds of the other vehicles in the lane to which a lane change is to be made with respect to the vehicle 1, are received from the vehicle control ECU 3, the CPU 41 stores such data in the RAM 42, and thereafter proceeds to the processing in S14.

In S14, the CPU 41 acquires the vehicle position on the basis of the result of the detection performed by the current location detection processing section 11, Then, the CPU 41 executes determination processing in which it is determined whether or not the vehicle position has reached a deceleration start location at which deceleration for starting a lane change is started, i.e. whether or not the vehicle has passed the deceleration start location. The CPU 41 determines that the vehicle position has reached the deceleration start location, i.e. the vehicle has passed the deceleration start location, when the distance from the vehicle position to the branch point for guidance which requires a lane change ahead of the vehicle has become equal to or less than 2 km, for example. Then, in the case where it is determined that the vehicle position has not reached the deceleration start location, that is, that the vehicle has not passed the deceleration start location (S14: NO), the CPU 41 proceeds to the processing in S15.

In S15, the CPU 41 reads, from the RAM 42, data such as the distance of the lateral space of the vehicle 1 in the lane to which a lane change is to be made, e.g. data on the relative positional relationship of the other vehicles in the lane to which a lane change is to be made with respect to the vehicle 1. Then, the CPU 41 executes determination processing in which it is determined whether or not a space that allows a lane change is present at a side of the vehicle 1 to which a lane change is to be made. Then, in the case where it is determined that a space that allows a lane change is not present at a side of the vehicle 1 to which a lane change is to be made (S15: NO), the CPU 41 ends the processing. In the case where it is determined that a space that allows a lane change is present at a side of the vehicle 1 to which a lane change is to be made (515: YES), on the other hand, the CPU 41 proceeds to the processing in S18 to be discussed later.

In the case where it is determined in S14 that the vehicle position has reached the deceleration start location, that is, that the vehicle has passed the deceleration start location (S14: YES), on the other hand, the CPU 41 proceeds to the processing in S16. In S16, the CPU 41 executes the processing in S15. Then, in the case where it is determined that a space that allows a lane change is present at a side of the vehicle 1 to which a lane change is to be made (S16: YES), the CPU 41 proceeds to the processing in S18 to be discussed later. In the case where it is determined that a space that allows a lane change is not present at a side of the vehicle 1 to which a lane change is to be made (S16: NO), on the other hand, the CPU 41 proceeds to the processing in S17.

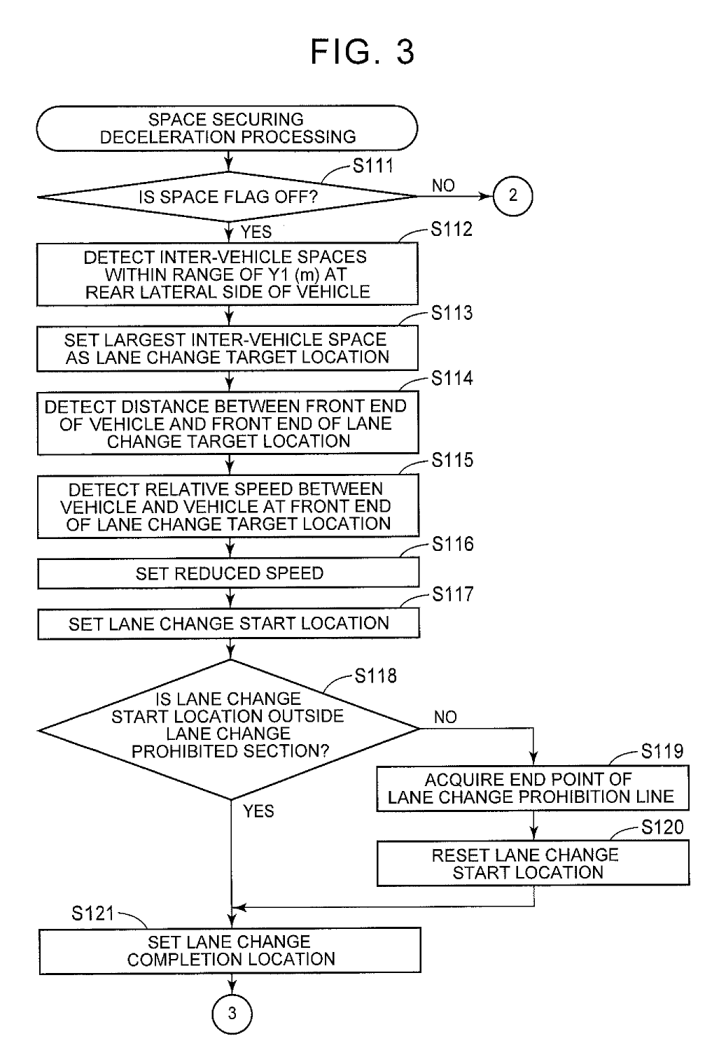

After sub processing “space securing deceleration processing” to be discussed later (see FIG. 3) is executed in S17, the CPU 41 proceeds to the processing in S18. In S18, the CPU 41 acquires the vehicle position on the basis of the result of the detection performed by the current location detection processing section 11. Subsequently, the CPU 41 executes determination processing in which it is determined, on the basis of the navigation map information 26, whether or not the vehicle position is outside a lane change prohibited section defined by a lane change prohibition line, that is, whether or not the vehicle 1 is traveling outside the lane change prohibited section.

Then, in the case where it is determined that the vehicle position is not outside the lane change prohibited section defined by the lane change prohibition line, that is, that the vehicle 1 is not traveling outside the lane change prohibited section (S18: NO), the CPU 41 ends the processing. In the case where it is determined that the vehicle position is outside the lane change prohibited section defined by the lane change prohibition line, that is, that the vehicle 1 is traveling outside the lane change prohibited section (S18: YES), the CPU 41 proceeds to the processing in S19.

In S19, the CPU 41 executes determination processing in which it is determined, on the basis of the navigation map information 26, whether or not the start point of the lane change prohibition line in the travel direction of the vehicle 1 is absent within a certain distance, e.g. within 100 m, ahead of the vehicle position. Then, in the case where it is determined that the start point of the lane change prohibition line in the travel direction of the vehicle 1 is not absent within a certain distance, e.g. within 100 m, ahead of the vehicle position (S19: NO), the CPU 41 ends the processing. In the case where it is determined that the start point of the lane change prohibition line in the travel direction of the vehicle 1 is absent within a certain distance, e.g. within 100 m, ahead of the vehicle position (S19: YES), on the other hand, the CPU 41 proceeds to the processing in S20.

In S20, the CPU 41 requests the vehicle control ECU 3 to make a lane change to the lane at a side. Consequently, the CPU 71 of the vehicle control ECU 3 controls drive of an engine device, a brake device, an electric power steering system, and so forth (not illustrated) to make a lane change.

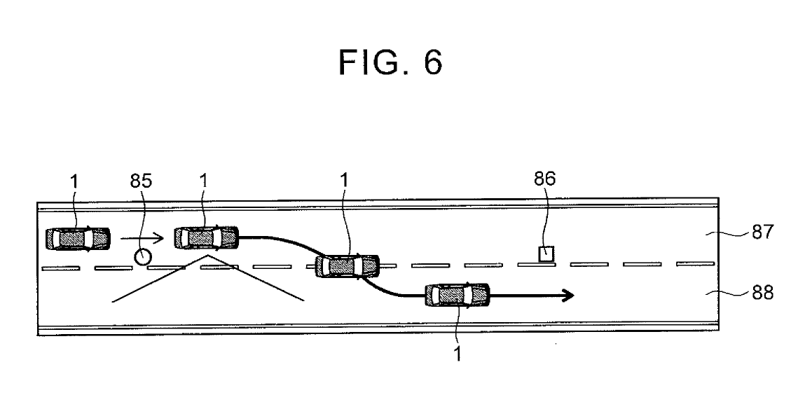

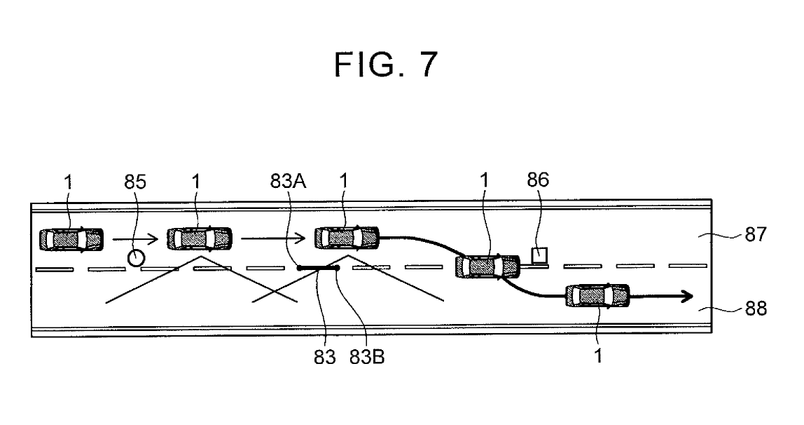

A specific example of the lane change made in the case where there is a space that allows a lane change at a side of the vehicle 1 when the vehicle 1 has passed the lateral detection start location will be described with reference to FIGS. 6 and 7.

In the case where it is determined that the vehicle position has reached a lateral detection start location 85, i.e. that the vehicle has passed the lateral detection start location 85 (S12: YES) as illustrated in FIG. 6, for example, the CPU 41 requests the vehicle control ECU 3 to measure a lateral space of the vehicle 1 in the lane to which a lane change is to be made. Then, the CPU 41 receives, from the vehicle control ECU 3, data indicating that there is a space that allows a lane change at a side of the vehicle 1 (S13).

Then, since the vehicle 1 has not reached a deceleration start location 86 (S14: NO), there is a space that allows a lane change at a side of the vehicle 1 (S15: YES), the vehicle position is not in the lane change prohibited section (S18: YES), and further the start point of the lane change prohibition line in the travel direction of the vehicle 1 is not present within a certain distance ahead of the vehicle position (S19: YES), the CPU 41 requests the vehicle control ECU 3 to make a lane change to the lane at a side. Consequently, the CPU 71 of the vehicle control ECU 3 controls drive of the engine device, the brake device, the electric power steering system, and so forth (not illustrated) to make a lane change from a left lane 87 to a right lane 88 (S20) without performing deceleration control and without exiting normal travel.

In addition, in the case where it is determined that the vehicle position has reached a lateral detection start location 85, i.e. that the vehicle has passed the lateral detection start location 85 (S12: YES) as illustrated in FIG. 7, for example, the CPU 41 requests the vehicle control ECU 3 to measure a lateral space of the vehicle 1 in the lane to which a lane change is to be made. Then, the CPU 41 receives, from the vehicle control ECU 3, data indicating that there is a space that allows a lane change at a side of the vehicle 1 (S13).

Then, since the vehicle 1 has not reached the deceleration start location 86 (S14: NO), there is a space that allows a lane change at a side of the vehicle 1 (S15: YES), the vehicle position is not in the lane change prohibited section (S18: YES), but a start point 83A of the lane change prohibition line 83 in the travel direction of the vehicle 1 is present within a certain distance ahead of the vehicle position (S19: NO), the CPU 41 does not request the vehicle control ECU 3 to make a lane change. That is, the CPU 41 delays the start of a lane change.

After that, when the forward end portion of the vehicle 1 in the travel direction has reached an end point 83B of the lane change prohibition line 83 in the travel direction of the vehicle 1 (S12: YES), the CPU 41 requests the vehicle control ECU 3 to measure a lateral space of the vehicle 1 in the lane to which a lane change is to be made. Then, the CPU 41 receives, from the vehicle control ECU 3, data indicating that there is a space that allows a lane change at a side of the vehicle 1 (S13).

Then, since the vehicle 1 has not reached a deceleration start location 86 (S14: NO), there is a space that allows a lane change at a side of the vehicle 1 (S15: YES), the vehicle position is not in the lane change prohibited section (S18: YES), and further the start point of the lane change prohibition line in the travel direction of the vehicle 1 is not present within a certain distance ahead of the vehicle position (S19: YES), the CPU 41 requests the vehicle control ECU 3 to make a lane change to the lane at a side. Consequently, the CPU 71 of the vehicle control ECU 3 controls drive of the engine device, the brake device, the electric power steering system, and so forth (not illustrated) to make a lane change from a left lane 87 to a right lane 88 (S20) without performing deceleration control and without exiting normal travel.

Subsequently, as illustrated in FIG. 2, in S21, the CPU 41 reads a space flag from the RAM 42, sets the space flag to OFF, stores the flag in the RAM 42 again, and thereafter ends the processing. When the navigation apparatus 2 is started, the space flag is set to OFF and stored in the RAM 42.

Next, the sub processing “space securing deceleration processing”, which is executed by the CPU 41 in S17, will be described with reference to FIGS. 3, 4, and 8 to 10. As illustrated in FIG. 3, first, in S111, the CPU 41 reads the space flag from the RAM 42, and executes determination processing in which it is determined whether or not the space flag has been set to OFF. Then, in the case where it is determined that the space flag has not been set to OFF (S111: NO), the CPU 41 proceeds to the processing in S127 to be discussed later.

In the case where it is determined that the space flag has been set to OFF (S111: YES), on the other hand, the CPU 41 proceeds to the processing in S112. In S112, the CPU 41 requests the vehicle control ECU 3 to measure inter-vehicle spaces in rear of the vehicle 1 in the lane to which a lane change is to be made, that is, within the range of Y1 (m) at a rear lateral side of the vehicle, e.g. within the range of 200 m at a rear lateral side of the vehicle. Consequently, the CPU 71 of the vehicle control ECU 3 measures the inter-vehicle spaces within the range of Y1 (m) at a rear lateral side of the vehicle in the lane to which a lane change is to be made by performing image processing on image data captured by the rearward image capturing camera 76B, or using the millimeter wave radar 77, and outputs the measured inter-vehicle spaces to the navigation apparatus 2.

Then, when data such as the distance of the inter-vehicle spaces within the range of Y1 (m) at a rear lateral side of the vehicle in the lane to which a lane change is to be made, e.g. data on the relative positional relationship and the relative speeds of the other vehicles within the range of Y1 (m) at a rear lateral side of the vehicle in the lane to which a lane change is to be made with respect to the vehicle 1, are received from the vehicle control ECU 3, the CPU 41 stores such data in the RAM 42, and thereafter proceeds to the processing in S113. In S113, the CPU 41 sets the largest inter-vehicle space, of the inter-vehicle spaces of the other vehicles within the range of Y1 (m) at a rear lateral side of the vehicle in the lane to which a lane change is to be made, as a “lane change target location” to be entered when the vehicle 1 makes a lane change, and stores the lane change target location in the RAM 42.

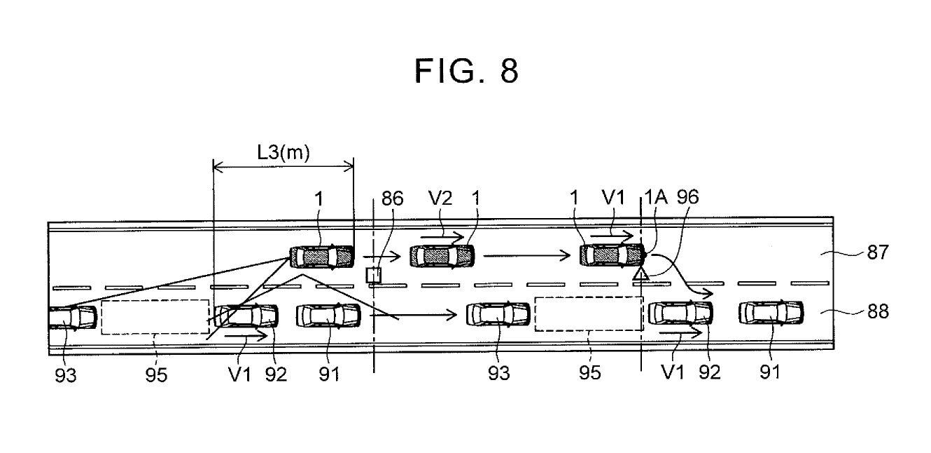

When the vehicle position is before the deceleration start location 86 in the travel direction of the vehicle 1 as illustrated in FIG. 8 (in FIG. 8, the vehicle 1 is positioned on the left side of the deceleration start location 86), for example, there is no space that allows a lane change between vehicles 91 and 92 positioned at a side of the vehicle 1. Meanwhile, the largest inter-vehicle space that can be entered when the vehicle 1 makes a lane change is present between vehicles 92 and 93 positioned within the range of Y1 (m) at a rear lateral side of the vehicle 1, that is, between the rear end portion of the vehicle 92 and the front end portion of the vehicle 93. In this case, the CPU 41 sets the inter-vehicle space between the rear end portion of the vehicle 92 and the front end portion of the vehicle 93 as a lane change target location 95 to be entered when the vehicle 1 makes a lane change, and stores the lane change target location 95 in the RAM 42.

Subsequently, as illustrated in FIG. 3, in S114, the CPU 41 reads, from the RAM 42, data on the relative positional relationship of the other vehicles within the range of Y1 (m) at a rear lateral side of the vehicle in the lane to which a lane change is to be made with respect to the vehicle 1, detects a distance L3 (m) (see FIG. 8) from the front end portion of the vehicle 1 to the front end of the lane change target location, that is, to the rear end portion of the other vehicle which is located ahead of the lane change target location in the travel direction, and stores the distance L3 in the RAM 42.

Then, in S115, the CPU 41 reads, from the RAM 42, data on the relative positional relationship and the relative speeds of the other vehicles within the range of Y1 (m) at a rear lateral side of the vehicle in the lane to which a lane change is to be made with respect to the vehicle 1, and detects the relative speed of the other vehicle which is located ahead of the lane change target location in the travel direction (in FIG. 8, the vehicle 92) with respect to the vehicle 1. Then, the CPU 41 acquires the vehicle speed of the vehicle 1 using the vehicle speed sensor 51, adds the relative speed to the vehicle speed, and stores the resulting speed in the RAM 42 as a speed V1 of the other vehicle which is located ahead of the lane change target location in the travel direction.

Subsequently, in S116, the CPU 41 sets a reduced speed V2 obtained by reducing the speed V1 of the other vehicle which is located ahead of the lane change target location in the travel direction by 10% to 20%, preferably by about 10%, as the vehicle speed at which the vehicle 1 travels from the deceleration start location, and stores the reduced speed V2 in the RAM 42. In the case where the vehicle speed of the vehicle 92 is the speed V1 as illustrated in FIG. 8, for example, the reduced speed V2 which is obtained by reducing the speed V1 by about 10% is stored in the RAM 42 as the vehicle speed at which the vehicle 1 travels from the deceleration start location 86.

Then, in S117, the CPU 41 sets the coordinate position (e.g. the latitude and the longitude) of a location at which the front end portion of the vehicle 1 in the travel direction and the front end portion of the lane change target location, that is, the rear end portion of the other vehicle which is located ahead of the lane change target location in the travel direction, are substantially side by side with each other when the vehicle 1 travels at the reduced speed V2 from the deceleration start location as the coordinate position of a lane change start location at which a lane change is started, and stores the coordinate position in the RAM 42.

Specifically, the CPU 41 multiplies a travel time, which is obtained by dividing the distance L3 (m) from the front end portion of the vehicle 1 to the rear end portion of the other vehicle which is located ahead of the lane change target location in the travel direction by a speed difference between the speed V1 of the other vehicle and the reduced speed V2, by the speed V1 of the other vehicle to determine the resulting product as the distance from the deceleration start location to the lane change start location. Then, the CPU 41 acquires, on the basis of the navigation map information 26, the coordinate position of a location at which the along-the-way distance from the deceleration start location matches the calculated distance, and stores the acquired coordinate position in the RAM 42 as the coordinate position of the lane change start location. The distance from the lane change start location to the branch point for guidance which requires a lane change ahead of the vehicle is desirably set to about 1000 m to about 700 m.

For example, as illustrated in FIG. 8, the CPU 41 sets the coordinate position (e.g. the latitude and the longitude) of a location at which the front end portion of the vehicle 1 and the front end portion of the lane change target location 95, which is the rear end portion of the vehicle 92, are substantially side by side with each other when the vehicle 1 travels at the reduced speed V2 from the deceleration start location 86 as the coordinate position of a lane change start location 96 at which a lane change is started, and stores the coordinate position in the RAM 42.

Subsequently, in S118, the CPU 41 executes determination processing in which it is determined whether or not the lane change start location is positioned outside the lane change prohibited section. Then, in the case where it is determined that the lane change start location is positioned outside the lane change prohibited section (S118: YES), the CPU 41 proceeds to the processing in S121 to be discussed later. In the case where it is determined that the lane change start location is not positioned outside the lane change prohibited section (S118: NO), the CPU 41 proceeds to the processing in S119.

In S119, the CPU 41 acquires, on the basis of the navigation map information 26, the coordinate position (e.g. the latitude and the longitude) of the end point, in the travel direction of the vehicle 1, of the lane change prohibition line which defines the lane change prohibited section in which the lane change start location is positioned. Then, in S120, the CPU 41 sets the coordinate position of the end point of the lane change prohibition line in the travel direction of the vehicle 1 as a new lane change start location, and stores the new lane change start location in the RAM 42,

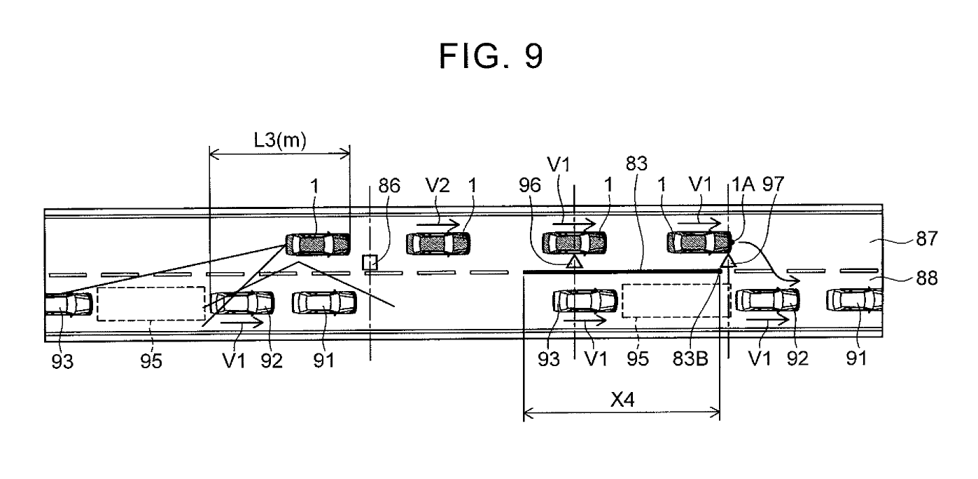

In the case where the lane change start location 96 for the vehicle 1 is positioned in a lane change prohibited section X4 (S118: NO) as illustrated in FIG. 9, for example, the CPU 41 acquires, on the basis of the navigation map information 26, the coordinate position of the end point 83B of the lane change prohibition line 83 which defines the lane change prohibited section X4 in the travel direction of the vehicle 1 (S119). Then, the CPU 41 sets the coordinate position of the end point 83B of the lane change prohibition line 83 in the travel direction of the vehicle 1 as a new lane change start location 97 in place of the lane change start location 96, and stores the coordinate position in the RAM 42 as the new lane change start location 97 (S120).

After that, as illustrated in FIG. 3, in S121, the CPU 41 sets a lane change completion location, at which a lane change is completed, at a location a predetermined distance, e.g. 200 m to 300 m, ahead of the lane change start location, the distance of 200 m to 300 m corresponding to a distance traveled by the vehicle 1 at the speed V1 of the other vehicle for about 10 seconds. Then, the CPU 41 acquires the coordinate position of the lane change completion location on the basis of the navigation map information 26, and stores the coordinate position in the RAM 42.

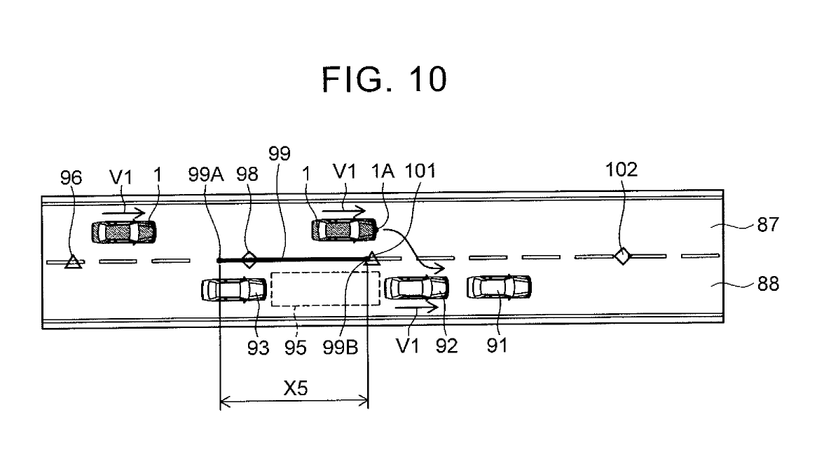

For example, as illustrated in FIG. 10, the CPU 41 sets a lane change completion location 98 at a location 200 m to 300 m ahead of the lane change start location 96, the distance of 200 m to 300 m corresponding to a distance traveled by the vehicle I at the speed V1 of the other vehicle for about 10 seconds. Then, the CPU 41 acquires the coordinate position of the lane change completion location 98 on the basis of the navigation map information 26, and stores the coordinate position in the RAM 42.

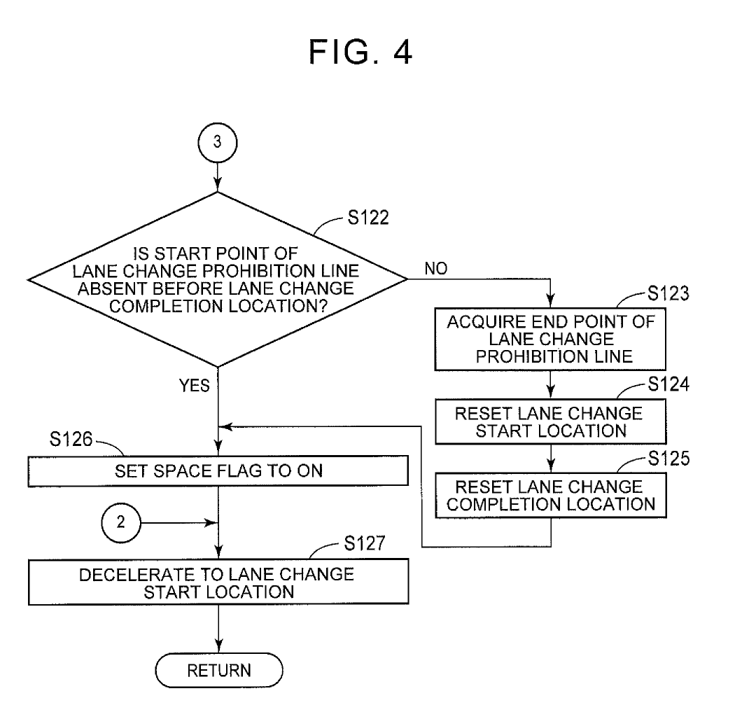

Subsequently, as illustrated in FIG. 4, in S122, the CPU 41 executes determination processing in which it is determined whether or not the start point of the lane change prohibition line (second lane change prohibition line) in the travel direction of the vehicle 1 is absent before the lane change completion location. That is, the CPU 41 executes determination processing in which it is determined, on the basis of the navigation map information 26, whether or not the lane change completion location is positioned in the lane change prohibited section. Then, in the case where it is determined that the start point of the lane change prohibition line (second lane change prohibition line) in the travel direction of the vehicle 1 is not present before the lane change completion location, that is, that the lane change completion location is not positioned in the lane change prohibited section (S122: YES), the CPU 41 proceeds to the processing in S126 to be discussed later.

In the case where it is determined that the start point of the lane change prohibition line (second lane change prohibition line) in the travel direction of the vehicle 1 is present before the lane change completion location, that is, that the lane change completion location is positioned in the lane change prohibited section (S122: NO), the CPU 41 proceeds to the processing in S123 to be discussed later. In S123, the CPU 41 acquires, on the basis of the navigation map information 26, the coordinate position (e.g. the latitude and the longitude) of the end point, in the travel direction of the vehicle 1, of the lane change prohibition line (second lane change prohibition line) which defines the lane change prohibited section in which the lane change completion location is positioned.

Then, in S124, the CPU 41 sets the coordinate position of the end point of the lane change prohibition line (second lane change prohibition line) in the travel direction of the vehicle 1 as a new lane change start location, and stores the new lane change start location in the RAM 42. Subsequently, in S125, the CPU 41 sets a new lane change completion location at a location a predetermined distance, e.g. 200 m to 300 m, ahead of the end point of the lane change prohibition line (second lane change prohibition line) in the travel direction of the vehicle 1, the distance of 200 m to 300 m corresponding to a distance traveled by the vehicle 1 at the speed V1 of the other vehicle for about 10 seconds. Then, the CPU 41 acquires the coordinate position of the new lane change completion location on the basis of the navigation map information 26, and stores the coordinate position in the RAM 42.

In the case where it is determined that a start point 99A of a lane change prohibition line 99 (second lane change prohibition line) in the travel direction of the vehicle 1 is present before the lane change completion location 98, that is, that the lane change completion location 98 is positioned in a lane change prohibited section X5 (S122: NO), as illustrated in FIG. 10, for example, the CPU 41 acquires, on the basis of the navigation map information 26, the coordinate position of an end point 99B of the lane change prohibition line 99 in the travel direction of the vehicle 1 (S123).

Then, the CPU 41 sets the coordinate position of the end point 99B of the lane change prohibition line 99 in the travel direction of the vehicle 1 as a new lane change start location 101 in place of the lane change start location 96, and stores the coordinate position of the lane change start location 101 in the RAM 42 (S124). Subsequently, the CPU 41 sets a new lane change completion location 102 at a location a predetermined distance, e.g. 200 m to 300 m, ahead of the end point 99B of the lane change prohibition line 99 in the travel direction of the vehicle 1, the distance of 200 m to 300 m corresponding to a distance traveled by the vehicle 1 at the speed V1 of the other vehicle for about 10 seconds. Then, the CPU 41 acquires the coordinate position of the new lane change completion location 102 on the basis of the navigation map information 26, and stores the coordinate position in the RAM 42.

After that, as illustrated in FIG. 4, in S126, the CPU 41 reads the space flag from the RAM 42, sets the space flag to ON, and stores the flag in the RAM 42 again. Subsequently, in S127, the CPU 41 reads, from the RAM 42, the reduced speed V2 set in S116, the speed V1 of the other vehicle, and the coordinate position of the lane change completion location set in S121 or S121 and S125, and transmits such information to the vehicle control ECU 3. Then, the CPU 41 instructs the vehicle control ECU 3 to travel at the reduced speed V2 from the deceleration start location to the lane change start location so as to secure an inter-vehicle space that allows a lane change, and thereafter ends the sub processing “space securing deceleration processing”, returns to the main flowchart, and proceeds to the processing in S18.

A specific example in which the vehicle 1 decelerates from the deceleration start location to the lane change start location and thereafter makes a lane change at the lane change start location will be described with reference to FIGS. 8 to 10.

In the case where the lane change start location 96 is located outside the lane change prohibited section as illustrated in FIG. 8, for example, the CPU 41 instructs the vehicle control ECU 3 to travel at the reduced speed V2 from the deceleration start location 86 to the lane change start location 96 (S127). Consequently, the CPU 71 of the vehicle control ECU 3 controls drive of the engine device, the brake device, the electric power steering system, and so forth (not illustrated) such that the vehicle travels at the reduced speed V2 from the deceleration start location 86 to the lane change start location 96.

Then, the CPU 41 acquires the vehicle position on the basis of the result of the detection performed by the current location detection processing section 11, and instructs the vehicle control ECU 3 to make a lane change to the lane at a side at the speed V1 that is the same as the speed V1 of the vehicle 92 in the case where it is determined that a forward end portion 1A of the vehicle 1 in the travel direction has reached the lane change start location 96. Consequently, the CPU 71 of the vehicle control ECU 3 controls drive of the engine device, the brake device, the electric power steering system, and so forth (not illustrated) to make a lane change from the left lane 87 to the right lane 88 at the speed V1 to enter the lane change target location 95 before reaching the lane change completion location (S20).

Meanwhile, in the case where the lane change start location 96 is located in the lane change prohibited section as illustrated in FIG. 9, for example, the CPU 41 instructs the vehicle control ECU 3 to travel at the reduced speed V2 from the deceleration start location 86 to the former lane change start location 96, and to thereafter travel at the speed V1 that is the same as the speed V1 of the vehicle 92 from the former lane change start location 96 to the new lane change start location 97 (S127). Consequently, the CPU 71 of the vehicle control ECU 3 controls drive of the engine device, the brake device, the electric power steering system, and so forth (not illustrated) such that the vehicle travels at the reduced speed V2 from the deceleration start location 86 to the former lane change start location 96, and thereafter travels at the speed V1 that is the same as the speed VI of the vehicle 92 from the former lane change start location 96 to the new lane change start location 97.

Then, the CPU 41 acquires the vehicle position on the basis of the result of the detection performed by the current location detection processing section 11, and instructs the vehicle control ECU 3 to make a lane change to the lane at a side at the speed V1 that is the same as the speed V1 of the vehicle 92 in the case where it is determined that the forward end portion 1A of the vehicle 1 in the travel direction has reached the new lane change start location 97. Consequently, the CPU 71 of the vehicle control ECU 3 controls drive of the engine device, the brake device, the electric power steering system, and so forth (not illustrated) to make a lane change from the left lane 87 to the right lane 88 at the speed V1 to enter the lane change target location 95 before reaching the lane change completion location (S20).

Meanwhile, in the case where the lane change completion location 98 is located in the lane change prohibited section X5 as illustrated in FIG. 10, for example, the CPU 41 instructs the vehicle control ECU 3 to travel at the reduced speed V2 from the deceleration start location 86 to the former lane change start location 96, and to thereafter travel at the speed V1 that is the same as the speed V1 of the vehicle 92 from the former lane change start location 96 to the new lane change start location 101 (S127). Consequently, the CPU 71 of the vehicle control ECU 3 controls drive of the engine device, the brake device, the electric power steering system, and so forth (not illustrated) such that the vehicle travels at the reduced speed V2 from the deceleration start location 86 to the former lane change start location 96, and thereafter travels at the speed V1 that is the same as the speed V1 of the vehicle 92 from the former lane change start location 96 to the new lane change start location 101.

Then, the CPU 41 acquires the vehicle position on the basis of the result of the detection performed by the current location detection processing section 11, and instructs the vehicle control ECU 3 to make a lane change to the lane at a side at the speed V1 that is the same as the speed V1 of the vehicle 92 in the case where it is determined that the forward end portion 1A of the vehicle 1 in the travel direction has reached the new lane change start location 101. Consequently, the CPU 71 of the vehicle control ECU 3 controls drive of the engine device, the brake device, the electric power steering system, and so forth (not illustrated) to make a lane change from the left lane 87 to the right lane 88 at the speed V1 to enter the lane change target location 95 before reaching the lane change completion location 102 (S20).

With the vehicle 1 according to the embodiment, as has been described in detail above, in the case where the lane change start location is located in the lane change prohibited section when the lane change start location is set after the reduced speed V2 is set, the CPU 41 of the navigation apparatus 2 resets the lane change start location at the end point, in the travel direction of the vehicle 1, of the lane change prohibition line which defines the lane change prohibited section. Consequently, a lane change can be made through automated drive on a road on which the lane change prohibition line is present at the timing when the lane change prohibition line is ended, Thus, a lane change can be made through automated drive outside the lane change prohibited section before the branch point for guidance which requires a lane change.

In addition, the CPU 41 sets a lane change completion location, at which a lane change is completed, at a location a predetermined distance, e.g. 200 m to 300 m, ahead of the lane change start location, the distance of 200 m to 300 m corresponding to a distance traveled by the vehicle 1 at the speed V1 of the other vehicle for about 10 seconds. Consequently, the CPU 41 can instruct the vehicle control ECU 3 to make a lane change without reducing the vehicle speed at the lane change start location.

In addition, in the case where the start point of the lane change prohibition line in the travel direction of the vehicle 1 is present before the lane change completion location in the case where the lane change completion location is set, the CPU 41 resets the lane change start location at the end point of the lane change prohibition line. Then, the CPU 41 sets a new lane change completion location at a location a predetermined distance ahead of the new lane change start location. Consequently, it is possible to reliably prevent the vehicle from entering the lane to which a lane change is to be made across the lane change prohibition line after a lane change is started through automated drive on a road on which the lane change prohibition line is present. In addition, a lane change can be made through automated drive on a road on which the lane change prohibition line is present at the timing when the lane change prohibition line is ended.

In addition, in the case where there is an inter-vehicle space that enables a lane change within the range of Y1 (m) at a rear lateral side of the vehicle, the CPU 41 sets, on the basis of the relative positional relationship and the relative speeds of the other vehicles with respect to the vehicle 1, the reduced speed V2 which is obtained by reducing the speed V1 of the other vehicle which is located ahead of the lane change target location in the travel direction by 10% to 20%. Then, the CPU 41 sets the lane change start location at a location at which the forward end portion of the vehicle 1 and the front end portion of the lane change target location are substantially side by side with each other when the vehicle 1 travels at the reduced speed V2. Consequently, the vehicle control ECU 3 performs control such that the vehicle travels at the reduced speed V2 in the case where the deceleration start location is passed, so that the front end portion of the vehicle and the front end portion of the lane change target location are side by side with each other when the lane change start location is reached. This allows the vehicle to start a lane change to enter the lane change target location to make a lane change through automated drive.

In addition, the CPU 41 determines that the vehicle position has reached the lateral detection start location when the distance to the branch point for guidance which requires a lane change ahead of the vehicle has become equal to or less than 3 km, for example. Then, in the case where a space that allows a lane change is present at a side when a lateral space of the vehicle 1 is measured, the CPU 41 requests the vehicle control ECU 3 to make a lane change to the lane at a side. In this case, in addition, in the case where the start point of the lane change prohibition line in the travel direction of the vehicle 1 is present within a certain distance ahead of the vehicle position and the deceleration start location has not been reached, the CPU 41 requests the vehicle control ECU 3 to make a lane change to the lane at a side at the end point of the lane change prohibition line. Consequently, the vehicle 1 can make a lane change without deceleration during automated drive.

It should be understood that the inventive principles are not limited to the embodiment described above, and that various improvements and modifications may be made without departing from the scope of those principles. In the embodiment, automated drive, which does not rely on operations by the driver, has been described as drive in which the vehicle control ECU 3 controls all the operations including an accelerator operation, a brake operation, and a steering operation, which are related to the behavior of the vehicle, among operations on the vehicle. However, automated drive, which does not rely on operations by the driver, may be drive in which the vehicle control ECU 3 controls at least one of the operations including an accelerator operation, a brake operation, and a steering operation, which are related to the behavior of the vehicle, among operations on the vehicle. On the other hand, manual drive, which relies on operations by the driver, has been described as drive in which the driver performs an accelerator operation, a brake operation, and a steering operation, which are related to the behavior of the vehicle, among operations on the vehicle.

While an automated drive assisting device according to a specific embodiment has been described above, the automated drive assisting device may be configured as described below, and the following effect can be achieved in such cases.

For example, a first configuration is as follows.

The automated drive assisting device is characterized in that the control means has: distance determination means for determining whether or not a distance of a section from the vehicle to the branch point for guidance other than the lane change prohibited section is equal to or more than a distance that allows a lane change; and start location setting means for setting a lane change start location, at which the vehicle starts a lane change, at a terminal end, in a travel direction of the vehicle, of a lane change prohibition line that indicates the lane change prohibited section which is positioned before the section other than the lane change prohibited section in the travel direction of the vehicle in the case where the distance determination means determines that the distance of the section other than the lane change prohibited section is equal to or more than the distance that allows a lane change.

With the automated drive assisting device configured as described above, in the case where the distance of the section other than the lane change prohibited section is equal to or more than the distance that allows a lane change, the lane change start location is set at the terminal end, in the travel direction of the vehicle, of the lane change prohibition line which is positioned before the section other than the lane change prohibited section in the travel direction of the vehicle. Consequently, it is possible to reliably start a lane change at the timing when the lane change prohibition line is ended, and to make a lane change in the section other than the lane change prohibited section.

A second configuration is as follows.

The automated drive assisting device is characterized by further including vehicle speed detection means for detecting a vehicle speed of the vehicle during travel; and is characterized in that the control means has completion location setting means for setting, on the basis of the vehicle speed detected by the vehicle speed detection means, a lane change completion location, at which a lane change is completed, ahead of the lane change start location in the travel direction of the vehicle.

With the automated drive assisting device configured as described above, the lane change completion location, at which a lane change is completed, is set ahead of the lane change start location in the travel direction of the vehicle on the basis of the vehicle speed, and therefore a lane change can be made without reducing the vehicle speed at the lane change start location.

A third configuration is as follows.

The automated drive assisting device is characterized by further including prohibition line determination means for determining, on the basis of the road information, whether or not a start point of a second lane change prohibition line is present on a side of the branch point for guidance with respect to the lane change start location in the travel direction of the vehicle and before the lane change completion location in the travel direction of the vehicle; and is characterized in that in the case where the prohibition line determination means determines that the start point of the second lane change prohibition line is present before the lane change completion location in the travel direction of the vehicle, the start location setting means resets the lane change start location, at which the vehicle starts a lane change, at a terminal end of the second lane change prohibition line in the travel direction of the vehicle.

With the automated drive assisting device configured as described above, in the case where the start point of the second lane change prohibition line is present on the side of the branch point for guidance with respect to the lane change start location in the travel direction of the vehicle and before the lane change start location in the travel direction of the vehicle, the lane change start location, at which the vehicle starts a lane change, is reset at the terminal end of the second lane change prohibition line. Consequently, even in the case where the distance from the terminal end of the lane change prohibition line to the start point of the second lane change prohibition line in the travel direction of the vehicle is short, the lane change start location can be reset at the end point of the second lane change prohibition line to make a lane change at the timing when the lane change prohibition line is ended through automated drive.

A fourth configuration is as follows.

The automated drive assisting device is characterized by further including other vehicle detection means for detecting a positional relationship and a relative speed between the vehicle and another vehicle that travels in a lane to which the vehicle is to make a lane change, deceleration determination means for determining, on the basis of the positional relationship and the relative speed between the vehicle and the other vehicle detected by the other vehicle detection means, whether or not it is necessary for the vehicle to decelerate before reaching the lane change start location, and deceleration start location setting means for setting a deceleration start location, at which deceleration is started, before the lane change start location in the travel direction of the vehicle in the case where the deceleration determination means determines that it is necessary for the vehicle to decelerate before reaching the lane change start location; and is characterized in that the control means performs control so as to start deceleration in the case where the vehicle has passed the deceleration start location.

With the automated drive assisting device configured as described above, in the case where it is determined, on the basis of the positional relationship and the relative speed between the vehicle and the other vehicle which travels in the lane to which the vehicle is to make a lane change, that it is necessary for the vehicle to decelerate before reaching the lane change start location, the deceleration start location is set before the lane change start location in the travel direction of the vehicle. Then, in the case where the vehicle has passed the deceleration start location, control is performed so as to start deceleration. Consequently, the deceleration start location is set before the lane change start location in the travel direction of the vehicle, and control is performed so as to start deceleration in the case where the vehicle has passed the deceleration start location. Therefore, a lane change can be made by changing the positional relationship with the other vehicle when the lane change start location is reached.

A fifth configuration is as follows,

The automated drive assisting device is characterized by further including vehicle speed detection means for detecting a vehicle speed of the vehicle during travel; and characterized in that the deceleration determination means has space determination means for determining whether or not a space that allows the vehicle to make a lane change is present with respect to a position of the other vehicle in the lane to which the vehicle is to make a lane change in the case where the vehicle has reached the lane change start location at the vehicle speed detected by the vehicle speed detection means; the deceleration determination means determines that it is not necessary for the vehicle to decelerate before reaching the lane change start location in the case where the space determination means determines that a space that allows the vehicle to make a lane change is present; and the deceleration determination means determines that it is necessary for the vehicle to decelerate before reaching the lane change start location in the case where the space determination means determines that a space that allows the vehicle to make a lane change is not present.

With the automated drive assisting device configured as described above, in the case where a space that allows the vehicle to make a lane change is present with respect to the position of the other vehicle in the lane to which the vehicle is to make a lane change in the case where the vehicle has reached the lane change start location, the vehicle does not decelerate before reaching the lane change start location, and therefore can make a lane change without deceleration. In the case where a space that allows the vehicle to make a lane change is not present with respect to the position of the other vehicle in the lane to which the vehicle is to make a lane change in the case where the vehicle has reached the lane change start location, on the other hand, the deceleration start location is set before the lane change start location in the travel direction of the vehicle. Consequently, control is performed so as to start deceleration in the case where the vehicle has passed the deceleration start location. Therefore, a lane change can be made by forming a space that allows the vehicle to make a lane change with respect to the position of the other vehicle in the lane to which the vehicle is to make a lane change when the lane change start location is reached.

A sixth configuration is as follows.

The automated drive assisting device is characterized in that the control means has speed acquisition means for acquiring a speed of the other vehicle by adding the relative speed between the vehicle and the other vehicle detected by the other vehicle detection means to the vehicle speed detected by the vehicle speed detection means; and the completion location setting means sets the lane change completion location at a location reached when the vehicle travels forward from the lane change start location at the speed of the other vehicle for a predetermined time.

With the automated drive assisting device configured as described above, the speed of the other vehicle is acquired by adding the relative speed between the vehicle and the other vehicle to the vehicle speed of the vehicle, and the lane change completion location is set at a location reached when the vehicle travels forward from the lane change start location at the speed of the other vehicle for a predetermined time. Therefore, the lane change completion location can be set immediately.

A seventh configuration is as follows.

The automated drive assisting device is characterized in that the control means has reduced speed setting means for setting a reduced speed obtained by reducing the speed of the other vehicle acquired by the speed acquisition means by a predetermined speed; and the start location setting means sets the lane change start location at a location at which a front end portion of the vehicle in the travel direction and a front end portion of the space that allows the vehicle to make a lane change are substantially side by side with each other when the vehicle travels at the reduced speed from the deceleration start location set by the deceleration start location setting means.

With the automated drive assisting device configured as described above, in the case where the vehicle travels from the deceleration start location to the lane change start location at the reduced speed which is obtained by reducing the speed of the other vehicle by a predetermined speed, the front end portion of the vehicle in the travel direction and the front end portion of the space that allows the vehicle to make a lane change are substantially side by side with each other. As a result, a lane change can be made through automated drive with the vehicle smoothly entering the space by starting a lane change when the vehicle has reached the lane change start location.

1. An automated drive assist device for a vehicle, the device comprising:
a processor programmed to:
acquire road information that includes information on a lane change prohibited section of a road on which the vehicle travels;
determine whether or not a lane change is to be made at a branch point for guidance positioned ahead of the vehicle during automated drive;
determine, on the basis of the road information, whether or not the vehicle is traveling on a road on which the lane change prohibited section is present; and
in the case where it is determined that a lane change is to be made at the branch point for guidance and the vehicle is traveling on the road on which the lane change prohibited section is present:
prohibit the vehicle from making a lane change in the lane change prohibited section; and
cause the vehicle to make a lane change in a section other than the lane change prohibited section before the branch point for guidance.

2. The automated drive assist device according to claim 1, wherein the processor is programmed to:
determine whether or not a distance of a section from the vehicle to the branch point for guidance other than the lane change prohibited section is equal to or more than a distance that allows a lane change; and
set a lane change start location, at which the vehicle starts a lane change, at a terminal end, in a travel direction of the vehicle, of a lane change prohibition line that indicates the lane change prohibited section which is positioned before the section other than the lane change prohibited section in the travel direction of the vehicle in the case where it is determined that the distance of the section other than the lane change prohibited section is equal to or more than the distance that allows a lane change.

3. The automated drive assist device according to claim 2, wherein the processor is programmed to:
detect a vehicle speed of the vehicle during travel; and
set, on the basis of the detected vehicle speed, a lane change completion location, at which a lane change is completed, ahead of the lane change start location in the travel direction of the vehicle.

4. The automated drive assist device according to claim 3, wherein the processor is programmed to:
determine, on the basis of the road information, whether or not a start point of a second lane change prohibition line is present on a side of the branch point for guidance with respect to the lane change start location in the travel direction of the vehicle and before the lane change completion location in the travel direction of the vehicle; and
in the case where it is determined that the start point of the second lane change prohibition line is present before the lane change completion location in the travel direction of the vehicle, reset the lane change start location, at which the vehicle starts a lane change, at a terminal end of the second lane change prohibition line in the travel direction of the vehicle.

5. The automated drive assist device according to claim 2, wherein the processor is programmed to:
detect a positional relationship and a relative speed between the vehicle and another vehicle that travels in a lane to which the vehicle is to make a lane change;
determine, on the basis of the detected positional relationship and the relative speed between the vehicle and the other vehicle, whether or not it is necessary for the vehicle to decelerate before reaching the lane change start location;
set a deceleration start location, at which deceleration is started, before the lane change start location in the travel direction of the vehicle in the case where it is determined that it is necessary for the vehicle to decelerate before reaching the lane change start location; and
control so as to start deceleration in the case where the vehicle has passed the deceleration start location.

6. The automated drive assist device according to claim 5, wherein the processor is programmed to:
detect a vehicle speed of the vehicle during travel; and
determine whether or not a space that allows the vehicle to make a lane change is present with respect to a position of the other vehicle in the lane to which the vehicle is to make a lane change in the case where the vehicle has reached the lane change start location at the detected vehicle speed;
determine that it is not necessary for the vehicle to decelerate before reaching the lane change start location in the case where is determined that the space that allows the vehicle to make a lane change is present; and
determined that it is necessary for the vehicle to decelerate before reaching the lane change start location in the case where it is determined that the space that allows the vehicle to make a lane change is not present.

7. The automated drive assist device according to claim 5, wherein the processor is programmed to:
acquire a speed of the other vehicle by adding the detected relative speed between the vehicle and the other vehicle to the detected vehicle speed; and
set the lane change completion location at a location reached when the vehicle travels forward from the lane change start location at the speed of the other vehicle for a predetermined time.

8. The automated drive assist device according to claim 7, wherein the processor is programmed to:
set a reduced speed obtained by reducing the acquired speed of the other vehicle by a predetermined speed; and
set the lane change start location at a location at which a front end portion of the vehicle in the travel direction and a front end portion of the space that allows the vehicle to make a lane change are substantially side by side with each other when the vehicle travels at the reduced speed from the set deceleration start location set.

9. An automated drive assist method for a vehicle, the method comprising:
determining whether or not a lane change is to be made at a branch point for guidance positioned ahead of the vehicle during automated drive;
determining, on the basis of acquired road information, whether or not the vehicle is traveling on a road on which the lane change prohibited section is present, the acquired road information including information on a lane change prohibited section of a road on which the vehicle travels; and
in the case where it is determined that a lane change is to be made at the branch point for guidance and the vehicle is traveling on the road on which the lane change prohibited section is present:
prohibiting the vehicle from making a lane change; and
causing the vehicle to make a lane change in a section other than the lane change prohibited section before the branch point for guidance.

10. A computer-readable storage medium storing an automated drive assist program for a vehicle, the program comprising instructions that causes a computer, to execute the following instructions:
determining whether or not a lane change is to be made at a branch point for guidance positioned ahead of the vehicle during automated drive;
determining, on the basis of acquired road information, whether or not the vehicle is traveling on a road on which the lane change prohibited section is present, the acquired road information including information on a lane change prohibited section of a road on which the vehicle travels; and
in the case where it is determined that a lane change is to be made at the branch point for guidance and the vehicle is traveling on the road on which the lane change prohibited section is present:
prohibiting the vehicle from making a lane change; and
causing the vehicle to make a lane change in a section other than the lane change prohibited section before the branch point for guidance.
